(19) United States
(12) Patent Application Publication
(10) Pub. No.: US 2002/0116845 A1
(43) Pub. Date: Aug. 29, 2002

(54) Apparatus for storing, identifying, and retrieving objects

(76) Inventor: Mary Ann Glover, Pittsburgh, PA (US)

Correspondence Address: JAMES RAY & ASSOCIATES, 2640 Pitcairn Road, Monroeville, PA, 15146, US

(21) Appl. No.: 09/792,723

(22) Filed: Feb. 23, 2001

(51) Int. Cl. G09F 3/00

(52) U.S. Cl. 40/312

(57) ABSTRACT

An apparatus for storing, identifying, and retrieving at least one predetermined object. The apparatus comprises a storage receptacle of a predetermined size, shape, and material. A plurality of compartments is disposed within the storage receptacle. Each compartment has a predetermined size and shape for storing such objects within the storage receptacle. The apparatus includes a first means engageable with a respective compartment to differentiate each compartment from another. A second means associated with the first means for cross-referencing a corresponding item that the object in the respective compartment belongs to is provided for locating and retrieving the object in the storage receptacle, whereby the corresponding item may be matched with the object that it belongs to.

### FIELD OF THE INVENTION

The present invention relates, in general, to the storage and retrieval of objects, and more particularly, to an apparatus for storing, identifying and retrieving objects.

### BACKGROUND OF THE INVENTION

Prior to the present invention, it is often necessary to store objects for future retrieval. Items such as spare buttons for clothing, spare keys, screws, and various other hardware objects are some examples. Objects that are stored for later use are usually randomly placed in drawers and boxes. However, without a logical system, it is difficult to easily and quickly retrieve the stored object when required. Either the location where the object is stored cannot be recalled, or it is stored in a single location, such as a drawer or a box, along with many other objects. This makes retrieval difficult and time consuming. For example, spare buttons are typically supplied with a new clothing item to be used when an original button is lost or broken. The spare buttons are removed upon receipt, and placed in a drawer, sewing box, or other receptacle. When the specific button is required, the user has to recall where the spare buttons are stored. If the spare buttons are stored in a box or drawer with many other spare buttons, the user has to tediously search through all the other buttons in order to locate and retrieve the desired button.

### SUMMARY OF THE INVENTION

In a first aspect, the present invention provides an apparatus for storing, identifying, and retrieving at least one predetermined object. The apparatus comprises a storage receptacle of a predetermined size, shape, and material. A plurality of compartments is disposed within the storage receptacle. Each compartment has a predetermined size and shape for storing objects within the storage receptacle. The apparatus also comprises a first means engageable with a respective compartment for identifying the respective compartment to differentiate each compartment from another. A second means associated with the first means for cross-referencing a corresponding item that the object in the respective compartment belongs to is provided for locating and retrieving the object.

In still a further aspect, the present invention provides an apparatus for storing, identifying, and retrieving at least one predetermined object. The apparatus comprises a storage receptacle of a predetermined size, shape, and material. A plurality of containers is disposed within the storage receptacle. Each container has a predetermined size and shape for storing the objects within the storage receptacle. The apparatus also comprises a first means engageable with a respective container for identifying the respective container to differentiate each container from the other. A second means associated with the first means for cross-referencing a corresponding item that the object in the respective container belongs to is provided for locating and retrieving the object.

### OBJECTS OF THE INVENTION

It is therefore the primary object of the present invention to provide an apparatus for storing predetermined objects in a logical, organized manner.

Another object of the present invention is to provide an apparatus for identifying stored predetermined objects in a systematic fashion for future retrieval.

Still a further object of the present invention is to provide an apparatus for easily and quickly retrieving stored predetermined objects.

In addition to the various objects of the invention that have been described above, various other objects and advantages of the invention will become more readily apparent to those persons skilled in the relevant art from the following more detailed description of the invention, particularly, when such description is taken in conjunction with the attached drawing figures and the appended claims.

### BRIEF DESCRIPTION OF THE DRAWINGS

FIG. 1 is an isometric view of a presently preferred embodiment of the apparatus;

FIG. 2 shows a means of cross-referencing a corresponding item;

FIG. 3 shows a master list for recording specific related information and cross-referencing a corresponding item; and

FIG. 4 is an isometric view of another presently preferred embodiment of the apparatus.

### BRIEF DESCRIPTION OF A PRESENTLY PREFERRED AND VARIOUS ALTERNATIVE EMBODIMENTS OF THE PRESENT INVENTION

Prior to proceeding to a more detailed description of the invention, it should be noted that identical components having identical functions have been designated with identical reference numerals for the sake of clarity.

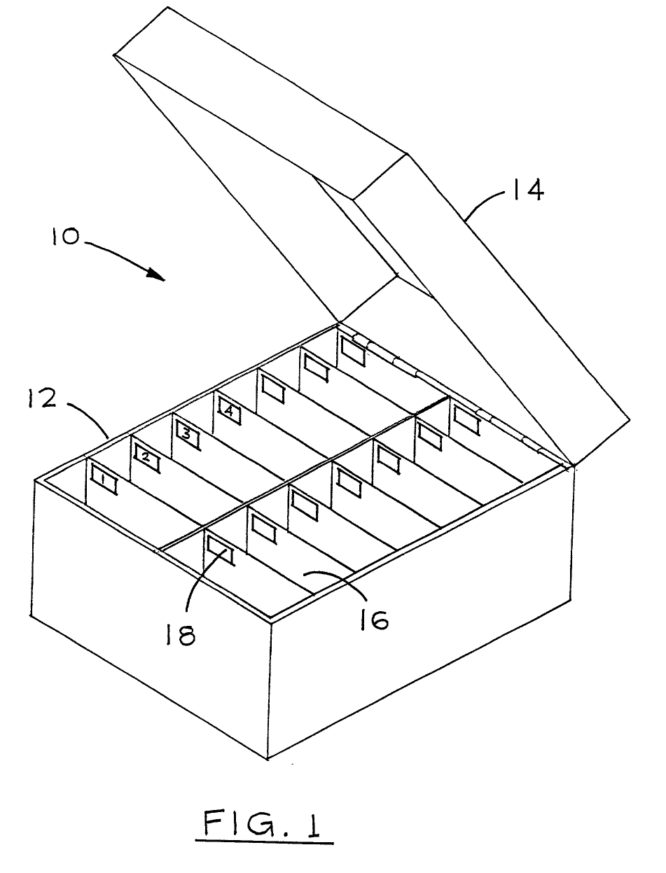

Now refer more particularly to FIGS. 1, 2, and 3 of the drawings. Illustrated in FIG. 1 is an apparatus, generally designated 10, for storing, identifying, and retrieving predetermined objects. The apparatus 10 comprises a storage receptacle 12 of a predetermined size, shape, and material. Preferably, the shape of the storage receptacle 12 is at least one of rectangular and square. For ease of storage, the preferred shape is rectangular. The presently preferred material of the storage receptacle 12 is at least one of plastic, paperboard, and metal. It is also preferred that the storage receptacle 12 includes a lid 14 of a predetermined size and shape, which is at least one of hingedly fixed to and removable from the storage receptacle 12.

A plurality of compartments 16 is disposed within the storage receptacle 12. The compartments 16 have a predetermined size and shape for storing objects within the storage receptacle 12. One compartment 16 in the storage receptacle 12 can be a different size and shape than at least one other compartment 16, and the size of each compartment can also be adjustable.

The apparatus includes a first means 18, engageable with a respective compartment 16 for identifying the respective compartment 16, to differentiate each compartment 16 from another. The preferred first means 18 is a distinct indicium, and is at least one of a number, letter, color, and other set of symbols. Application of the first means 18 to the respective compartment 16 is preferably by at least one of a label, marking instrument, and tag. The apparatus also includes a second means 20, associated with the first means 18, for cross-referencing a corresponding item that the object in the respective compartment 16 belongs to for locating and retrieving the object in the storage receptacle 12. The preferred second means 20 is a matching indicium, and is at least one of a number, letter, color, and other set of symbols. Application of the second means 20 to the corresponding item is preferably by at least one of a label, marking instrument, and tag.

Alternately, the second means 20 for cross-referencing a corresponding item can be a distinct indicium, and the first means 18 for identifying the respective compartment 16 will then be a matching indicium. The corresponding item is first identified with a distinct indicium. The respective container 26 is then identified with an indicium that matches the distinct indicium of the corresponding item.

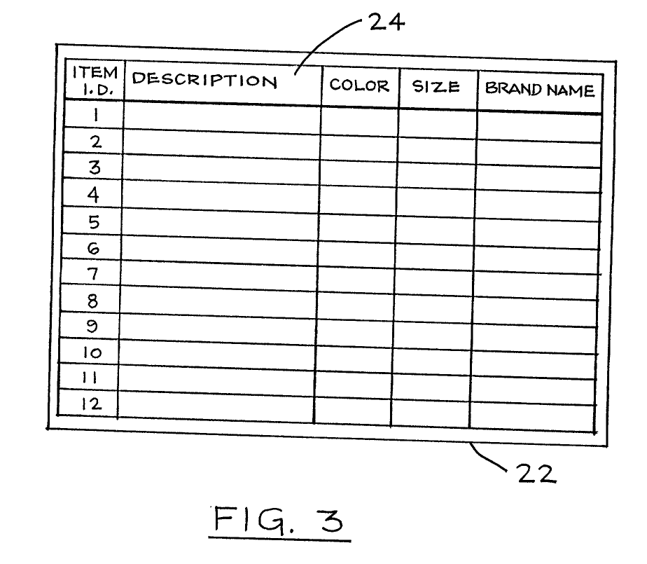

Another presently preferred means of matching a specific object with a corresponding item is a master list 22 of the corresponding items, which correlates to the compartments 16. The master list 22 cross-references the specific object in each compartment 16 with the corresponding item. As shown in FIG. 3, it is preferable that the master list 22 further includes a predetermined set of specific information 24 necessary to identify the corresponding item in order to locate the matching storage compartment 16 for retrieval of the specific object. Preferably, the predetermined set of specific information 24 is at least one of item type, color, size, brand, description, matching indicium, and distinct indicium of the corresponding compartment 16 in which the item is located in the storage receptacle 12. A photograph of each corresponding item can also be used as part of the master list 22. The master list 22 can also be created and maintained as a computer spread sheet, such as MICROSOFT WORD©, and EXCEL©. Using a spreadsheet program's typical search feature, the user can enter a key word of the corresponding item, and the program will retrieve the location of the specific compartment 16 of the object belonging to the corresponding item.

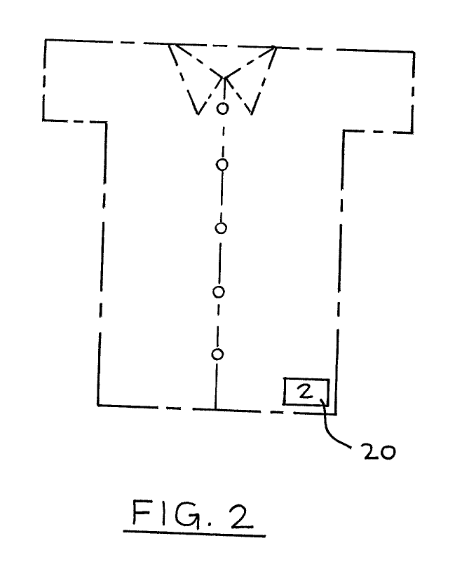

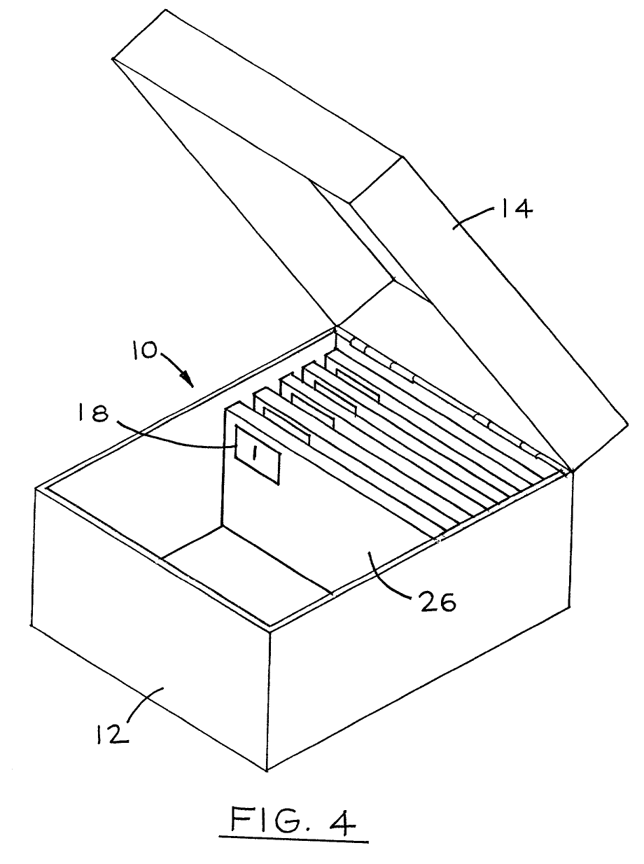

Now refer more particularly to FIGS. 2, 3, and 4 of the drawings. Illustrated in FIG. 4 is an apparatus, generally designated 10, for storing, identifying, and retrieving predetermined objects. The apparatus 10 comprises a storage receptacle 12 of a predetermined size, shape, and material. The shape of the storage receptacle 12 is at least one of rectangular and square. For ease of storage, the preferred shape is rectangular. The presently preferred material of the storage receptacle 12 is at least one of plastic, paperboard, and metal. It is also preferred that the storage receptacle 12 includes a lid 14 of a predetermined size and shape, which is at least one of hingedly fixed to and removable from the storage receptacle 12.

A plurality of containers 26 is disposed within the storage receptacle 12. The containers 26 have a predetermined size and shape for storing objects within the storage receptacle 12. One container 26 can be a different size and shape than at least one other container 26. Preferably, the containers 26 are removable from the storage receptacle 12, and are at least one of an envelope, drawer, box, and vial, or a combination thereof.

The apparatus includes a first means 18, engageable with a respective container 26 for identifying the respective container 26, to differentiate each container 26 from another. The preferred first means 18 is a distinct indicium, and is at least one of a number, letter, color, and other set of symbols. Application of the first means 18 to the respective container 26 is preferably by at least one of a label, marking instrument, and tag. The apparatus also includes a second means 20 for cross-referencing a corresponding item that the object in the respective container 26 belongs to for locating and retrieving the object in the storage receptacle 12. The preferred second means 20 is a matching indicium, and is at least one of a number, letter, color, and other set of symbols. Application of the matching indicium to the corresponding item is preferably by at least one of a label, marking instrument, and tag.

Alternately, the second means 20 for cross-referencing a corresponding item can be a distinct indicium, and the first means 18 for identifying the respective container 26 will then be a matching indicium. The corresponding item is first identified with a distinct indicium. The respective container 26 is then identified with an indicium that matches the distinct indicium of the corresponding item.

Another presently preferred means of matching a specific object with a corresponding item is a master list 22 of the corresponding items, which correlates to the containers 26. The master list 22 cross-references the object in each container 26 with its corresponding item. As shown in FIG. 3, it is preferable that the master list 22 further includes a predetermined set of specific information 24 necessary to identify the corresponding item in order to locate the matching container 26 for retrieval of the specific object. Preferably, the predetermined set of specific information 24 is at least one of item type, color, size, brand, description, distinct indicium and matching indicium. A photograph of each corresponding item can also be used as part of the master list 22. The master list 22 can also be created and maintained as a computer spread sheet, such as MICROSOFT WORD©, and EXCEL©.

### Operation

The apparatus of the invention is used in the following manner. An object is placed in a compartment 16, or container 28, wherein the compartment 16 or container 28 is identified by a first means 18, which is preferably a distinct indicium. The corresponding item that the object belongs to is then identified with a second means 20, which is preferably the matching indicium. For example, as can be seen in FIGS. 1 and 2, spare buttons that are received on a new clothing item may be placed in a compartment 16 or container 28. A distinct indicium is assigned or has been pre-assigned. The matching indicium, which is identical to the distinct indicium, is applied to the new clothing item by the most practical means, which is a label, marking instrument, or tag. A label with the matching indicium can be sewn onto the clothing item in an inconspicuous area, or the matching indicium can be applied to an area on the item with a marking instrument. Then, when a button from the clothing item needs replaced, the matching indicium on the clothing item is noted, and the spare button is retrieved from the compartment 16 or container 28 having the distinct indicium that corresponds to the matching indicium.

With the use of the master list 22, spare buttons from a clothing item are placed in a compartment 16 or container 28, and the specific information 24 about the clothing item is noted on the master list 22. The specific information can be the distinct indicium of the compartment 16 or container 28 in which the spare buttons are placed, the size, color, description, and brand name of the corresponding item. When the spare button is required, the clothing item is located on the master list 22, the distinct indicium of the compartment 16 or container 28 is identified, and the corresponding spare button is retrieved from the appropriate compartment 16 or container 28. Keys and hardware items are just a few of the many additional items that can be stored in this manner as well. Spare automobile keys, for example, may be most effectively stored and retrieved by using the master list 22, since it is more convenient to list the details of the corresponding item, the automobile, on the master list 22. The user will determine the best and most efficient method of identifying the corresponding item, depending on the physical attributes of the corresponding item.

Thus the reader will see that the present invention provides an apparatus for logically storing objects in one location, sufficiently identifying and cross-referencing those objects to the corresponding items to which they belong, and quickly and easily retrieving them when necessary.

Although the invention has been shown in connection with a certain specific embodiment, it will be readily apparent to those skilled in the art that various changes in form and arrangement of parts and method may be made to suit requirements without departing from the spirit and scope of the invention.

I claim:

1. An apparatus for storing, identifying, and retrieving at least one predetermined object, said apparatus comprising:
(a) a storage receptacle of a predetermined size, shape, and material;
(b) a plurality of compartments disposed within said storage receptacle, each compartment having a predetermined size and shape for storing at least one object within said storage receptacle;
(c) a first means engageable with a respective compartment for identifying said respective compartment to differentiate said each compartment from another; and
(d) a second means associated with said first means for cross-referencing a corresponding item that such object in said respective compartment belongs to for locating and retrieving such object in said storage receptacle, whereby such corresponding item may be matched with such object that it belongs to.

2. The apparatus according to claim 1 wherein said storage receptacle includes a lid of a predetermined size and shape, wherein said lid is at least one of hingedly fixed to and removable from said storage receptacle.

3. The apparatus according to claim 1 wherein said size of said each compartment is adjustable.

4. The apparatus according to claim 1 wherein said first means of identifying said respective compartment is a distinct indicium.

5. The apparatus according to claim 4 wherein said distinct indicium is at least one of a number, letter, color, and other set of symbols.

6. The apparatus according to claim 5 wherein said second means for cross-referencing such corresponding item is a matching indicium.

7. The apparatus according to claim 6 wherein said matching indicium is applied to such corresponding item by at least one of a label, marking instrument, and tag.

8. The apparatus according to claim 1 wherein said second means for cross-referencing such corresponding item is a distinct indicium.

9. The apparatus according to claim 8 wherein said distinct indicium is at least one of a number, letter, color, and other set of symbols.

10. The apparatus according to claim 9 wherein said first means for identifying said each compartment is a matching indicium.

11. The apparatus according to claim 10 wherein said matching indicium is applied to said each compartment by at least one of a label, marking instrument, and tag.

12. The apparatus according to claim 1 wherein said apparatus includes a master list of such corresponding items which correlates to said compartments for cross-referencing a specific object with such corresponding item.

13. The apparatus according to claim 12 wherein said master list further includes a p redetermined set of specific information necessary to identify such corresponding item in order to locate matching said storage compartment for retrieval of such specific object.

14. An apparatus for storing, identifying, and retrieving at least one predetermined object, said apparatus comprising:
(a) a storage receptacle of a predetermined size, shape, and material;
(b) a plurality of containers disposed within said storage receptacle, each container having a predetermined size and shape for storing at least one object within said storage receptacle;
(c) a first means engageable with a respective container for identifying said respective container to differentiate said each container from another; and
(d) a second means associated with said first means for cross-referencing a corresponding item that such object in said respective container belongs to for locating and retrieving such object in said storage receptacle, whereby such corresponding item may be matched with such object that it belongs to.

15. The apparatus according to claim 14 wherein said storage receptacle includes a lid of a predetermined size and shape, wherein said lid is at least one of hingedly fixed to and removable from said storage receptacle.

16. The apparatus according to claim 14 wherein said containers are at least one of an envelope, drawer, box, and vial.

17. The apparatus according to claim 14 wherein said apparatus includes a master list which correlates to said compartments for cross-referencing a specific object with such corresponding item.

18. The apparatus according to claim 17 wherein said master list further includes a predetermined set of specific information necessary to identify such corresponding item in order to locate matching said storage compartment for retrieval of such specific object.

19. The apparatus according to claim 18 wherein said predetermined set of specific information on said master list is created and maintained as a computer spreadsheet.

20. The apparatus according to claim 14 wherein said first means and said second means include a matching indicium.
